(19) United States
(12) Patent Application Publication
(10) Pub. No.: US 2006/0067173 A1
(43) Pub. Date: Mar. 30, 2006

(54) Annunciator and dynamically maintained play list for a juke box that plays digital audio files

(76) Inventors: John Robert Berkheimer, Scottsdale, AZ (US); Miles Martin Elmers II, Phoenix, AZ (US)

Correspondence Address: TYRELL CORPORATION;C/O THE HILL LAW FIRM PLC, 7035 NORTH 23RD AVE, PHOENIZ, AZ, 85021, US

(21) Appl. No.: 11/210,338

(22) Filed: Aug. 24, 2005

Related U.S. Application Data
(60) Provisional application No. 60/610,875, filed on Sep. 17, 2004.

(51) Int. Cl. G11B 7/085

(52) U.S. Cl. 369/30.06

(57) ABSTRACT

The present invention is a user interface for a juke box capable of playing digital audio files. The improved user interface uses an annunciator to illuminate track selection keys. Those track selection keys that are actuated to enter an access code associated with a song title are illuminated by the annunciator. Additionally, the annunciator illuminates the access code of a currently playing audio file when no access codes are being entered. Someone listening to music being played by the juke box can glance at the annunciator to determine which access code is being played, and then flip through a menu of song titles that are associated with the access codes to quickly look up what song is playing. In a preferred embodiment, the access codes are stored in a dynamic stack to build a super play list that can be easily managed on the juke box itself.

### CROSS REFERENCE TO RELATED APPLICATION

The present application is related to and claims priority under 35 U.S.C. 119(e) to U.S. Provisional Patent Application Ser. No. 60/610,875 filed Sep. 17, 2004, entitled “DIGITAL AUDIO PLAYER”, the contents of which are hereby incorporated by reference in their entirety.

### BACKGROUND OF THE INVENTION

Vintage juke boxes from the 40's and 50's had a simple and effective user interface. Their song library was printed on pages, often with a flipping mechanism, and each song was assigned an access code such as “J7” or “512”. Music was played back from records, so an update of a record selection usually required a qualified serviceman to open up the case of the juke box. Since updates required so much work, they were usually not done until several new songs were to be updated. Larger systems added “wall box” remote controls, most often seen at the tables in 50's diners, which allowed customers to easily select music without leaving their seat. A drawback of these vintage units is that a customer couldn't easily determine which song was currently playing unless they just recognized the track. A customer needed to walk over to the main juke box and check the display, if any, to find the name of the track. These larger systems were popular even though they were complex, expensive and difficult to maintain. Few examples remain operational today. Juke box systems are still popular, such as those shown and described in U.S. Pat. Nos. 6,031,795 and 6,587,403, but modern juke boxes use CD's instead of records for the playback of music, which may increase the number of selections available in some systems.

With the advent of digital music compression technology, such as the MP3 and WMA formats, the basic functionality of these juke boxes can now be carried in your pocket. Devices like the Apple iPod have become popular with the young and technically oriented. The all too common user interface for a typical MP3 player uses a tiny LCD screen, such as those shown in U.S. Pat. Nos. D486,813 and D452,250, having arrow buttons to navigate through various menus of artists, albums, and song titles. Although these devices are small, they can store thousands of songs. By being connected to a PC, a user can easily upload their entire music collection into the device. The tradeoff is that selecting a song title is now a tedious process. The tiny LCD screen can only show a few selections at a time, so many scrolling operations are needed to locate a desired track. The required connection to a PC can also be a drawback, being useful only to the more technically inclined users.

U.S. Pat. No. 6,629,197 issued Sep. 30, 2003 to Bhogal describes a method and system for an MP3 player with a completely different approach in its user interface. The system described has no tiny LCD screen with arrow keys, and instead emulates a CD changer found in many car audio systems. By interfacing to the car radio, this approach allows a user to select songs from an MP3 library as if they were selecting CD's from an actual CD changer mounted in their trunk, in the same comfortable manner they have been selecting music in their car for years.

### SUMMARY OF THE INVENTION

In order to enable more people to play music at home from a large selection of songs without needing more technical understanding, the present invention utilizes elements of a “vintage” user interface from a 50's juke box in combination with the operation of a digital audio player having improvements to enhance functionality and ease of use. The result is a portable system similar to a tabletop radio, but that will look more like a “wall box” remote from a 50's diner. The product has quick and easy access to at least 100 songs and does not require knowledge of a PC to change the available music selections. A CD based MP3 player system is preferred so that it can play commercially made compatible music CD's or it is easily updatable on a user's PC with new music selections.

Vintage juke boxes featured mechanical track selection buttons which were depressed to show the current entry, and all track selection buttons were illuminated all the time. Our track selection keys are enhanced by an annunciator, more specifically an electrically controlled indicator that incorporates an array of illumination means. There is at least one illumination means for each track selection key, which allows the annunciator to illuminate the access code of a recently entered song selection, similar to the feedback given by the depressed track selection keys of a vintage juke box. Our annunciator additionally has the ability to illuminate the access code of the currently playing song on the track selection keys themselves. This additional ability is especially useful for identifying a song title and artist of a randomly selected song. A user may simply glance at the access code illuminated by the annunciator and look up that access code on a song menu to learn title and artist information about a currently playing song.

Our juke box system is able to play the standard “play list” files used by other digital audio players, such as those shown and described in U.S. Pat. Nos. 6,388,958 and 6,446,080, to define a list of song tracks. These play list files have been previously created on a PC and are included along with the media files used by the player. Most preferably, our juke box is also able to play a “super play list” called the “stack”, which is dynamically maintained within the player “on the fly”. The stack allows numerous song selections to be entered to create a super play list managed within the player combined with a dedicated stack indicator, which is managed to provide status on the stacking process.

### BRIEF DESCRIPTION OF THE DRAWINGS

FIG. 1 is a perspective view the appearance of a juke box that incorporates the most preferred embodiment of the present invention.

FIG. 2 is an elevation view showing a sample of a preferred format of the printed flipping pages used to display the menu of song titles.

FIG. 3 is an elevation view showing a preferred arrangement of the track selection keys used with the juke box of FIG. 1.

FIG. 4 is an elevation view showing the preferred array of illumination means that forms a preferred annunciator that may be used behind the track selection keys of FIG. 3.

FIG. 5 is the preferred array of access codes derived from the printed flipping pages of FIG. 2.

FIG. 6 is a system block diagram showing a computer architecture in which the present invention may be implemented.

FIG. 7 is a flowchart showing some of the processing that may be performed in the main software loop of a digital audio file storage and playback unit in accordance with a preferred embodiment of the present invention.

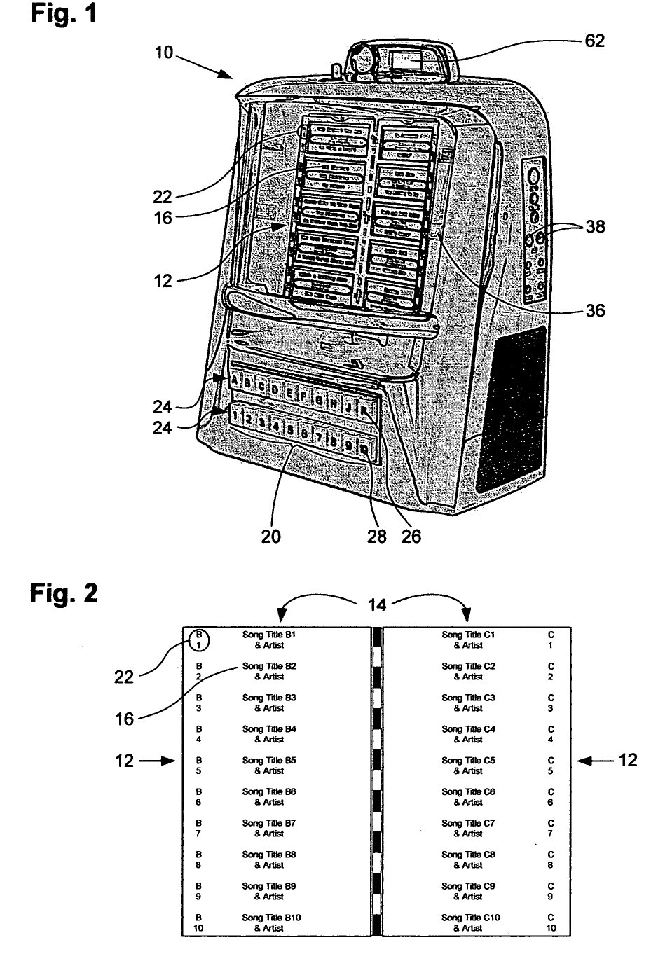

The following is the menu of numerical callouts used in FIGS. 1-7:

10 Jukebox
12 Printed flipping pages
14 menu
16 Song title
20 Track selection keys
22 Access code
24 Rows
26 Alpha keys
28 Numeric keys
30 Annunciator
32 Illumination means
34 Selected access code
36 Stack indicator light
38 Skip buttons
50 Power supply
52 Radio tuner
54 MPU (micro processor unit)
56 Digital audio storage unit
58 Amp and digital audio decoder
60 Speakers
62 LCD screen
70 Initialization
72 Key press
74 Process key press
76 Execute command
78 Stop mode
80 Determine next track
82 Update display
84 Power failure

### DETAILED DESCRIPTION OF THE INVENTION

The most preferred embodiment of the present invention, shown in FIG. 1, is a mobile or portable juke box 10 designed for storage and playback of digital audio files, and it combines our improved user interface with elements from a vintage juke box “wall box” found in a 50's diner. The improved user interface utilizes a digital audio system that is controlled at least partially by a computer processing means capable of playing digital audio files. Those of ordinary skill in the art will appreciate that the appearance shown in the various figures may vary depending on the system implementation. For example, the system may have many different configurations of track selection keys 20, possible styles for the printed flipping pages 12, and the system could also be floor size. The depicted examples are not meant to imply architectural limitations with respect to the present invention. The digital audio files may exist in compressed data formats, such as MP3, WMA, Real-Audio, or other suitable audio compression formats, or the files may exist in uncompressed format, which allows playback of standard format CD-DA compact discs. Although this description will discuss our most preferred embodiment, these preferences are not intended to exclude suitable or functionally equivalent alternatives.

To operate the system, a user browses song titles 16 displayed on a menu 14. The menu is typically maintained on numerous printed flipping pages 12, similar to a vintage juke box. Adjacent each of the song titles, there is an access code 22 that is at least partially comprised of symbols, preferably one alpha symbol and one numeric symbol. Access codes may be entered by a user to request playback of digital audio files associated with song titles. A user may enter a song selection by actuating a combination of track selection keys 20 bearing the symbols of the access code identified with a song title. The term “track selection keys” includes, but is not limited to, buttons and pushbuttons. FIG. 2 shows an example of the format of printed flipping pages that could be used with a 10×10 menu of song titles, noting that pages are usually displayed as pairs within the juke box unit. The access codes are shown along a border of each page to follow convention, but location of the access codes is a matter of preference. FIG. 5 shows the array of access codes that are available with a 10×10 menu of song titles.

For a large system, such as a 24×24 layout of song titles, the printed flipping pages may be grouped more tightly to save space such that twenty four pages can show twenty four songs per page, for a total of 576 possible song titles and access codes. A 24×24 layout preferably uses a row of alpha keys “A” through “Z”, skipping letters “I” and “O” to avoid confusion, and a row of numeric keys “1” through “24”. It should be noted that the access codes for a 10×10 layout can be duplicated by a 24×24 layout such that the same access code plays the same song on either system up to the limits of the system. This type of uniformity would allow the same digital media to be used on different systems, but only larger systems would have full access to all stored files. Another alternate layout includes a 20×10 layout that uses a first alpha row of track selection keys “A” through “K”, a second alpha row of track selection keys “L” through “V”, and a numeric row of track selection keys “1” through “10” Yet another alternate layout includes a 14×14 layout that uses an alpha row of track selection keys “A” through “P” and a numeric row of track selection keys “1” through “14”.

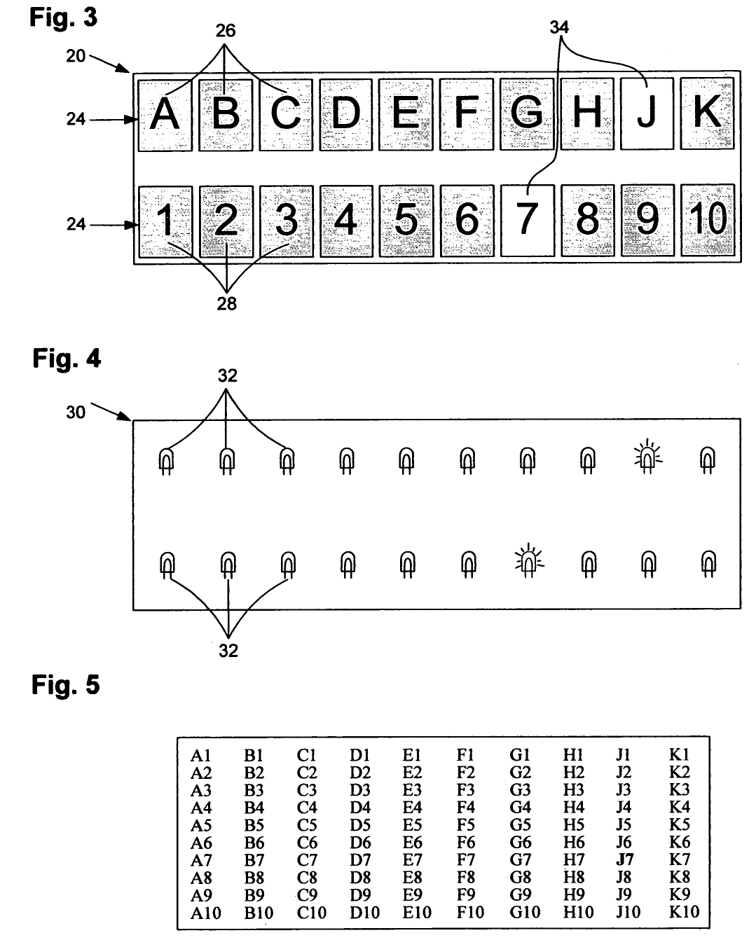

The track selection keys 20, most clearly shown in FIG. 3, preferably use hard keycaps that resemble the track selection keys used on vintage juke boxes, and the track selection keys are preferably at least partially a translucent plastic material to allow for a backlighting effect. To reduce the cost associated with a vintage juke box's long travel pushbutton switches, an inexpensive dome switch, PCB switch or suitable alternative may be used under each hard keycap. The track selection keys should be logically arranged in an array, such as rows 24 of adjacent track selection keys bearing one or more symbols. FIG. 3 shows a row of alpha keys 26 and a row of numeric keys 28. The track selection keys “J” and “7” are depicted as being backlighted, but as an alternative there could be LEDs that protrude through the keycaps, or even mechanical indicators that highlight or otherwise bring to the fore track selection keys.

The track selection keys may include as many rows of keys as desired, and the symbols don't need to be alpha or numeric. The two rows 24 of track selection keys 20 shown in the preferred embodiment may be supplemented by one or more additional track selection keys. A supplemental key is useful for further distinguishing an access code of a particular song title from access codes of other song titles on the menu. For example, supplemental Red and Blue track selection keys could be added as part of another row of keys that must be selected as a separate symbol of an access code, preferably indicating the color of a printed flipping page, so there could be a “Red J7” and a “Blue J7”.

Another method of increasing the number of possible selections is to require a double entry in one or more rows such that the number of access code symbols of a particular song title is greater than the number of rows of track selection keys, thereby requiring that more than one key in at least one of the rows must be actuated to enter an access code. For example, access code “J78” on a 10×10 layout would require a double entry in the numeric row. There should be no “J87” to avoid confusion, and it would not be possible to enter a “J77”, so the number of possible access codes increases from 100 to 450 on the already described 10×10 layout, noting that the “10” key should be changed to a “0” key.

To show off the track selection keys, vintage juke boxes illuminated all keys simultaneously with a backlighting effect. Our juke boxes use an annunciator 30, shown in FIG. 4, that allows each track selection key to be illuminated independently. The annunciator is an electrically controlled signal board, indicator or display that incorporates an array of illumination means 32. The term “illumination means” includes, but is not limited to, a means for lighting, backlighting, mechanically indicating, highlighting, or otherwise bringing to the fore. Our annunciator is preferably an array of electric lights that corresponds to and backlights the array of track selection keys such that there is at least one light source behind each track selection key. The electric lights can be traditional incandescent bulbs, LEDs, or any other desired illumination means of any desired wavelength, including color changing lights. The annunciator is used to provide feedback to a user by indicating whether a key has been actuated and/or whether a key is part of an access code being played by the juke box. FIGS. 3 and 4 show that “J7”, a selected access code 34, has either just been selected or is being played, which should be obvious to a user based on whether the user just entered an access code.

The annunciator may include colored LED lights that can be used as an alternate illumination means that uses an alternate wavelength of light. The alternate illumination means may correspond to colors on the printed flipping pages and there may be a second differently colored light behind each key, wherein the key color can be changed by pressing a key multiple times, thereby indicating a different color access code, which increases the number of possible selections available on a juke box, similar to the supplemental Red and Blue track selection keys already described.

The annunciator illuminates track selection keys according to the rules of a particular selection means. A user chooses which selection means will be implemented. Available selection means of the system preferably include a random play function of the computer processing means that randomly plays audio files from the menu of song titles, a continuous play function that systematically plays audio files in the order that song titles are shown on the printed pages, and a dynamic stack play function that plays audio files from a stack of access codes that have been entered, detected and stored in memory for later playback.

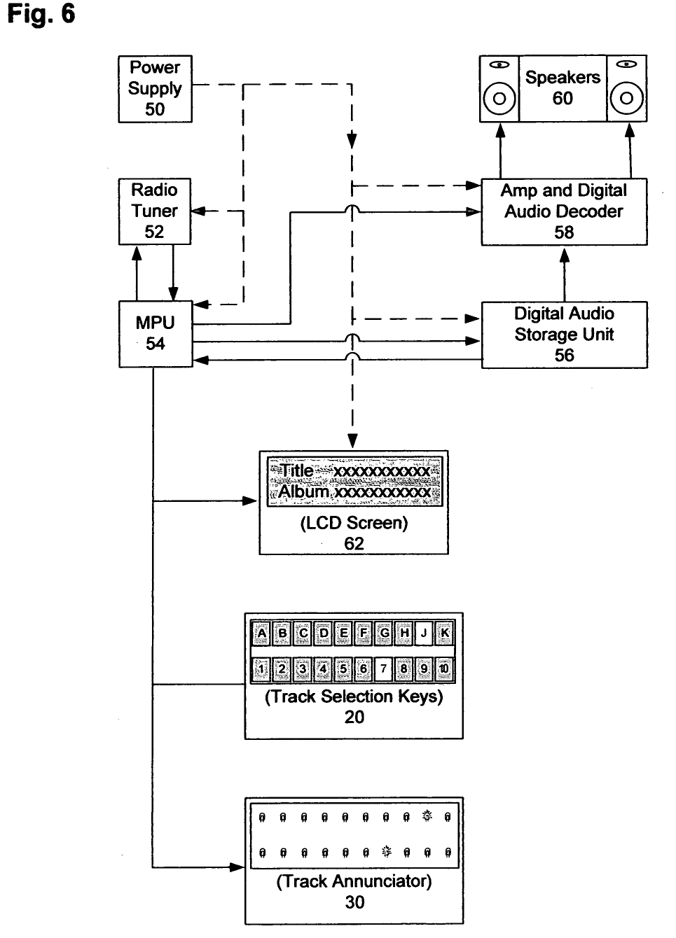

The juke box is controlled using a computer processing means for processing data. The computer processing means is capable of scanning track selection keys, powering the illumination means, playing related audio files, and otherwise controlling the electronic functions of the juke box unit. A preferred data processing system, shown in the block diagram of FIG. 6, is a digital audio system with a basic computer architecture. Those of ordinary skill in the art will appreciate that the hardware may vary depending on the system implementation, and this description is not meant to imply architectural limitations. For example, the system may have one or more processors, and other peripheral devices may be used in addition to or in place of the hardware described.

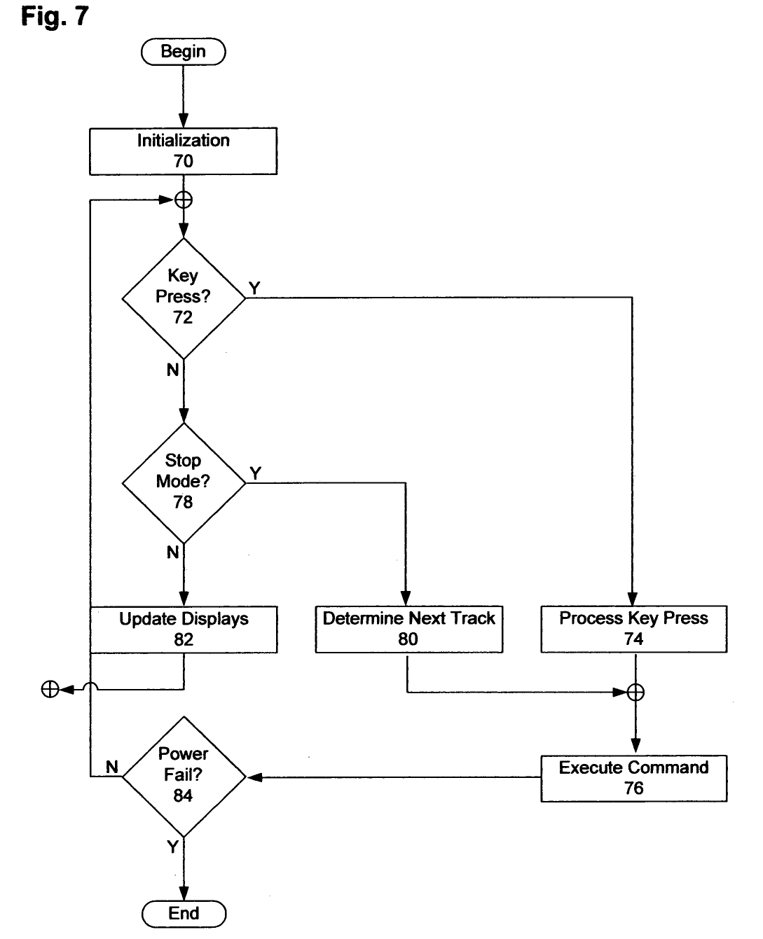

The data processing system is controlled by an MPU 54 (micro processing unit) that scans a large array of switches, allowing a user to control the system. Power to the system is provided by a power supply 50. The MPU can be a common controller, such as an Intel 8051 eight bit microcontroller, which integrates the memory and other peripherals required into a single inexpensive chip. One group of the scanned switches forms the track selection keys 20. This group of switches features individually controlled electric lights for each switch to form the annunciator 30. It is desirable to share the same matrix for both scanning track selection keys and driving the annunciator to minimize the total number of I/O pins required in the MPU. Feedback to the user is also provided by an LCD screen 62 that can scroll text and otherwise display system status. An optional radio tuner 52 can be added to the system to provide an alternate input. The MPU controls the digital audio storage unit 56, as well as an optional radio tuner. Based on a user's selection, the system provides audio streams to an amp and digital audio decoder 58 that drives speakers 60.

Where a user's selection is from a database, the possible databases may be stored in any form of digital memory, including CD, hard drive, or FLASH. In addition to being able to be implemented on a variety of hardware platforms, the present invention may be implemented in a variety of software environments. A typical operating system or software runtime environment may be used to control program execution within the data processing system. FIG. 7 shows a flowchart of a preferred main loop of an operating system suitable for the computer processor of the present invention. The main loop, which shows some of the processing that may be performed by the MPU, is the highest level of the software. The main loop begins when power is applied from a power supply. The system performs a startup Initialization step 70. The MPU then scans keys, including the track selection keys, until the system detects a key press 72 from a user. When a key press is detected, there is a process key press step 74 that causes the system to execute a command 76, such as to update the annunciator, to play an audio file, or to power on the system. Unless there is a power failure 84, once a command is executed the system waits to detect the next key press. If no next key press is detected, then the system tests for entry into a stop mode 78, which is usually when an audio file has completed playback and the system must now determine the next track 80, if any, to be played. If stop mode is not detected, then the system will update displays 82. This main loop never ends unless power to the system is lost.

It should be noted that if no key press is detected, then the system preferably will update displays 82 and cause the LCD screen 62 to scroll and update any audio file position counters. The LCD screen is just an additional way to provide feedback to the user, such as by scrolling track information including the song, artist and album names, but can also indicate mode changes and other system status. The LCD screen can also be used to show the number of access codes that are stored in the stack. Status concerning the stack is provided by a stack indicator light 36 that indicates to a user whether the stack is being processed by the computer processing means. The stack indicator light will preferably be lighted when the stack is being played, and flash when the stack is being modified.

Our dynamic stack play function adds the exciting capability of being able to manage and edit the stack, which is a super play list, within the player itself. Current MP3 players and juke boxes can execute a menu of songs, or “play list”. Different play lists can be selected, and playback can be stopped or skipped, etc. However, play lists can not be easily added to without actually editing the list. Editing permanently affects a play list, and it is generally a complex process not able to be done on the player itself. Our system can play these play list files as well, but our dynamic stack is much more versatile and does not require much in the way of technical skills. When a user enters an access code while another song is playing, the newly entered selection is “stacked” and played after the current song ends. Multiple selections can be easily stacked, and will be played in due time. When all selections are played, the stack may be discarded so that the system returns to a chosen background mode of operation, or the stack may be continuously repeated. A continuously repeated stack is a very custom environment, suitable for a wedding or other formal occasions, and it is performed when the computer processing means reprocesses the stack after the juke box finishes playing all of the related audio files.

The dynamic stack may be built during playback. Although the annunciator 30 may be temporarily interrupted and used to illuminate track selection keys 20 of newly entered access codes 22 that are being sent to the stack, playback continues normally. The stacking means preferably stores user selected access codes sequentially in the stack. The computer processing means processes the stack, substantially in the order that the stack was stored, and causes the annunciator to indicate which selected access code 34, such as “J7”, is being processed by the computer processing means to let the user know what is playing. If the stack does not have any stored user selected access codes, the computer processing means preferably plays audio files in the order they appear on the menu 14 until a user actuates track selection keys and enters a new access code into the stack. If an undesirable song is playing from the stack, there are forward and backward skip buttons 38 that allow a user to browse within the stack.

When a complete access code is entered and detected by the MPU, the access code is displayed by the annunciator and converted into a file location where the digital audio file is stored. There is a playback means, such as the amp and digital audio decoder 58 with speakers 60 shown in FIG. 6, for playback of a digital audio file associated with an access code. The selection means of the system decides whether to immediately play the new selection or stack the selection for later playback. When a track is currently playing, the new selection is usually stacked, but this can be affected by different operating modes of the system. For example, a simple selection means can be defined which will play the new selection immediately. This interrupt play function will stop whatever the system is doing and play the digital audio file associated with an access code right after it is detected, interrupting the currently playing track.

How the MPU associates a detected access code with an audio file is a software function. A common method of linking an access code to a digital audio file is to define the files to be accessed in a format similar to a standard play list file (.M3U for MP3's, etc.). The preferred method is to create a separate file folder for each of the access codes, store the audio files and any information that could be displayed by the LCD screen in the correct file folder, and then just direct the MPU to the correct file folder when it is time to play an access code. To enhance this approach, the method of using a special page “tag” is utilized to divide the menu into groups for each page. The page tag can be a simple pattern such as [Page] or [JB_Page], etc. These page groups can be calculated to provide a first level index. A second level index can be calculated from the tracks position within a page group. This approach requires extra work to prepare this special menu file and include it along with the other media tracks. The best approach would be to supply custom software for a PC which would keep track of the media files assigned to each access code and would be capable of writing or “burning” the CD and printing the flipping pages as well. For the extra work, this approach provides the advantage of allowing a single media file to be accessed by multiple access codes without requiring multiple copies of the track to exist, providing an ultimate degree of flexibility.

As already mentioned, the overall function of the juke box unit may be enhanced by adding a radio tuner that provides signals in the system. Indicator lights that are similar to the stack indicator light can be added to show whether the system is playing from the stack, an FM radio, a CD, an MP3 disc, or some other desired source. When the radio tuner is being used, the track selection keys can alternately function as preset buttons for storing and selecting radio stations. Since the unit will have twenty or more track selection keys on a front panel of the juke box, a large number of station memories can be quickly accessed by pressing a single key. To extend the Vintage user interface to the radio, additional printed flipping pages can be added to display the radio station memories.

While a preferred form of the invention has been shown and described, it will be realized that alterations and modifications may be made thereto without departing from the scope of the following claims. For example, there are many additional ways of making and arranging track selections keys (such as on a touch screen), of illuminating track selection keys, and of displaying the menu of song titles (such as on an LCD screen instead of printed pages).

What is claimed is:

1. A user interface for a juke box comprising:
a menu of song titles, each song title on the menu being adjacent an access code comprised of symbols;
at least two rows of track selection keys, each key bearing at least one symbol;
an annunciator for illuminating track selection keys;
a selection means for selecting one or more track selection keys;
a computer processing means for processing data; and
wherein the selection means causes those track selection keys bearing the symbols associated with a selected access code to illuminate substantially while the computer processing means plays a related audio file through the juke box.

2. The user interface for a juke box of claim 1 further comprising numerous printed flipping pages for displaying the menu of song titles.

3. The user interface for a juke box of claim 1 further comprising a radio player means that allows at least some of the track selection keys to alternately be used to store and select preset radio stations.

4. The user interface for a juke box of claim 1 wherein the annunciator is an array of illumination means such that there is at least one illumination means substantially adjacent each key of the at least two rows.

5. The user interface for a juke box of claim 4 further comprising an alternate illumination means for alternately illuminating track selection keys using an alternate wavelength of light.

6. The user interface for a juke box of claim 1 wherein the selection means is at least partially characterized by a random play function of the computer processing means that randomly plays audio files from the menu.

7. The user interface for a juke box of claim 1 wherein the selection means is at least partially characterized by a continuous play function of the computer processing means that systematically plays audio files in an order that at least partially corresponds to the menu of song titles.

8. The user interface for a juke box of claim 1 wherein the selection means is at least partially characterized by an interrupt play function of the computer processing means that plays an audio file after a user actuates track selection keys associated with a selected access code.

9. The user interface for a juke box of claim 1 wherein the number of access code symbols of a particular song title is greater than the number of rows of track selection keys such that more than one key in at least one of the at least two rows may be caused to illuminate while the audio file for a particular song title plays.

10. A user interface for a juke box comprising:
a menu of song titles, each song title on the menu being adjacent an access code comprised of symbols;
an array of track selection keys, each key bearing at least one symbol;
an annunciator for illuminating track selection keys;
a stacking means for sequentially storing user selected access codes in a stack;
a computer processing means for processing data;
wherein the computer processing means processes the stack, substantially in the order that the stack was stored, and causes those track selection keys bearing the symbols associated with a user selected access code to illuminate at least partially while the computer processing means plays a related audio file through the juke box; and
wherein the annunciator may be temporarily interrupted and used to illuminate track selection keys when a user actuates the track selection keys to enter a new access code into the stack.

11. The user interface for a juke box of claim 10 wherein the computer processing means reprocesses the stack after the juke box finishes playing all of the related audio files.

12. The user interface for a juke box of claim 10 wherein, if the stack does not have any stored user selected access codes, the computer processing means plays audio files in the order they appear on the menu until a user actuates track selection keys and enters a new access code into the stack.

13. The user interface for a juke box of claim 10 further comprising forward and backward skip buttons that allow a user to browse within the stack.

14. The user interface for a juke box of claim 10 further comprising a stack indicator light that indicates to a user whether the stack is being processed by the computer processing means.

15. The user interface for a juke box of claim 10 further comprising a stack indicator light that blinks substantially when a user actuates the track selection keys to enter a new access code into the stack.

16. The user interface for a juke box of claim 10 further comprising an LCD screen that provides feedback to a user.

17. A user interface for a juke box comprising:
a menu of song titles, each song title on the menu being adjacent an access code;
a row of alpha track selection keys;
a row of numeric track selection keys;
a playback means for playback of an audio file associated with an access code; and
an annunciator that incorporates an array of illumination means that corresponds to and can illuminate the alpha track selection keys and the numeric track selection keys such that an access code of a song title can be illuminated substantially during playback.

18. The user interface for a juke box of claim 17 further comprising at least one supplemental key having an illumination means, the at least one supplemental key being useful for further distinguishing an access code of a particular song title from access codes of other song titles on the menu.

19. The user interface for a juke box of claim 18 wherein the at least one supplemental key identifies a color.

20. The user interface for a juke box of claim 18 wherein the at least one supplemental key is part of another row of alpha or numeric track selection keys.
